(19) United States
(12) Patent Application Publication
(10) Pub. No.: US 2026/0098791 A1
(43) Pub. Date: Apr. 9, 2026

(54) PARTICLE CAPTURING DEVICE

(71) Applicants: The University of Tokyo, Tokyo (JP); CANON MEDICAL SYSTEMS CORPORATION, Otawara-shi (JP)

(72) Inventors: Soo Hyeon KIM, Bunkyo (JP); Yoshinobu SUGITANI, Bunkyo (JP); Teruo FUJII, Bunkyo (JP); Hiroyuki FUJITA, Toshima (JP); Koji YANO, Setagaya (JP); Kohei WATANABE, Utsunomiya (JP)

(73) Assignees: The University of Tokyo, Tokyo (JP); CANON MEDICAL SYSTEMS CORPORATION, Otawara-shi (JP)

(21) Appl. No.: 19/351,622

(22) Filed: Oct. 7, 2025

(30) Foreign Application Priority Data
Oct. 8, 2024 (JP) 2024-176557

(51) Int. Cl. G01N 1/34; B01L 3/00

(52) U.S. Cl. CPC G01N 1/34; B01L 3/502761; B01L 2200/0647; B01L 2400/0424

(57) ABSTRACT

A particle capturing device according to an embodiment includes an electrode pair and a capture membrane. A voltage is applied to the electrode pair. The capture membrane is configured to be provided on the electrode pair and is provided along at least one surface of a flow path to capture particles contained in a fluid flowing in the flow path by dielectrophoresis. A coupling well for capturing the particles is formed in the capture membrane. The coupling well has a plurality of first wells connected to each other.

### CROSS REFERENCE TO RELATED APPLICATIONS

This application is based upon and claims the benefit of priority from the prior Japanese Patent Application No. 2024-176557, filed on Oct. 8, 2024, the entire contents of which are incorporated herein by reference.

### FIELD

Embodiments disclosed in the present specification and drawings relate to a particle capturing device.

### BACKGROUND

Conventionally, a particle capturing device that captures particles such as cells contained in a fluid into micro-wells or the like for each size using dielectrophoresis is known. Such a particle capturing device is used, for example, in a case where small blood cells such as lymphocytes and red blood cells and circulating tumor cells (CTC) are separately arrayed and detected, or in a case where blood cells of various sizes are separated.

In the case of capturing particles in a well using dielectrophoresis, the smaller the size of the well, the larger the dielectrophoretic force per unit area. Therefore, if the size of the well is simply reduced, non-specific capture occurs, and particles having a small size cannot be selectively captured.

### BRIEF DESCRIPTION OF THE DRAWINGS

FIG. 1 is a perspective view of a particle capturing device according to one embodiment.

FIG. 2 is a plan view of the particle capturing device according to one embodiment.

FIG. 3 is a schematic plan view of a coupling well according to one embodiment.

FIG. 4 is a cross-sectional view illustrating an operation example of the particle capturing device according to one embodiment.

FIG. 5 is an enlarged view illustrating an operation example of the particle capturing device according to one embodiment.

FIG. 6 is a diagram illustrating an example of target particles in the particle capturing device according to one embodiment.

FIG. 7 is a diagram illustrating simulation results of electric fields formed in various wells in the particle capturing device according to one embodiment and a comparative example.

FIG. 8 is a graph illustrating the magnitude of the gradient of the electric field intensity formed on each first well in a coupling well according to one embodiment and an uncoupling well according to the comparative example.

FIG. 9 is a diagram illustrating results of capturing experiment of second target particles in the particle capturing device according to one embodiment.

FIG. 10 is a diagram illustrating results of capturing experiment of second target particles in the particle capturing device according to the comparative example.

FIG. 11 is a diagram illustrating results of an experiment for capturing first target particles in a coupling well according to one embodiment and an uncoupling well according to the comparative example.

FIG. 12 is a graph illustrating results of an experiment for capturing first target particles in a coupling well according to one embodiment and an uncoupling well according to the comparative example.

FIG. 13 is a diagram illustrating results of another experiment for capturing first target particles in a coupling well according to one embodiment.

FIG. 14 is a diagram illustrating results of another experiment for capturing first target particles in an uncoupling well according to the comparative example.

FIG. 15 is a view illustrating a state of first target particles on a connection well in a coupling well according to one embodiment.

FIG. 16 is a view illustrating a state of electric fields on a connection well in a coupling well according to one embodiment.

FIG. 17 is a diagram illustrating results of experiment of fractionating and capturing the first target particles and the second target particles in the particle capturing device according to one embodiment.

FIG. 18 is a graph illustrating results of experiment of fractionating and capturing the first target particles and the second target particles in the particle capturing device according to one embodiment.

FIG. 19 is a schematic plan view of a coupling well according to a first modification of one embodiment.

FIG. 20 is a plan view of the particle capturing device according to a second modification of one embodiment.

FIG. 21 is a schematic view of the particle capturing device according to a third modification of one embodiment.

FIG. 22 is a plan view of the particle capturing device according to a fourth modification of one embodiment.

FIG. 23 is a plan view of the particle capturing device according to a fifth modification of one embodiment.

FIG. 24 is a diagram illustrating a relationship between a direction of an axis of a coupling well according to one embodiment and an ability to capture first target particles of the coupling well.

FIG. 25 is a diagram illustrating a relationship between sizes of the first and second well and sizes of target particles according to one embodiment.

### DETAILED DESCRIPTION

Hereinafter, respective embodiments of the particle capturing device will be described with reference to the accompanying drawings. In the embodiments below, the same reference signs are given for identical components in terms of configuration and function, and duplicate description is omitted.

### <Particle Capturing Device>

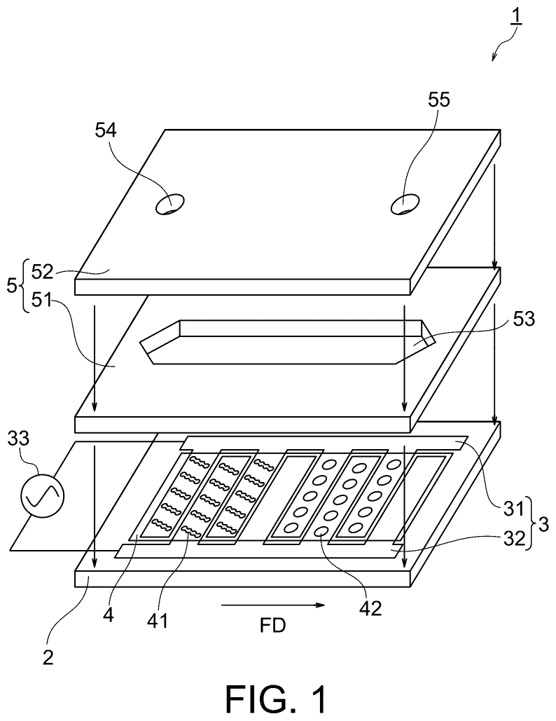

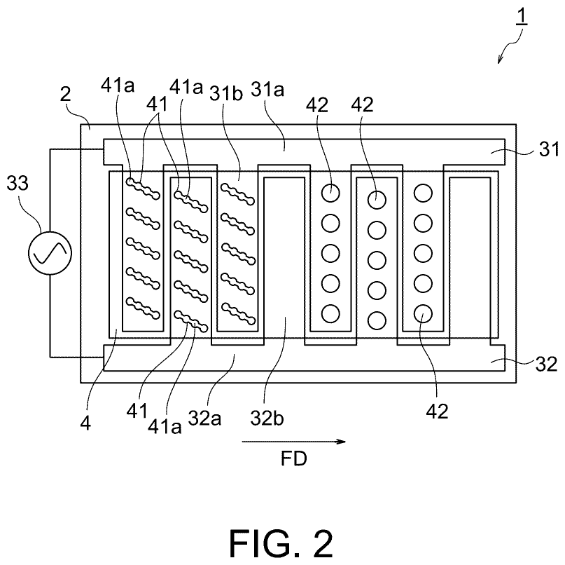

A particle capturing device 1 according to one embodiment will be described with reference to FIGS. 1 and 2. FIG. 1 is a perspective view of the particle capturing device 1 according to one embodiment. FIG. 2 is a plan view of the particle capturing device 1 according to one embodiment. In FIG. 2, a cover member 5 is omitted.

The particle capturing device 1 is a device that captures particles contained in a fluid by dielectrophoresis. More specifically, the particle capturing device 1 is a device that includes a fluid channel as a flow path through which fluid containing particles of different sizes flows, and fractionates and captures the particles in the fluid by size by dielectrophoresis to perform arraying. In FIGS. 1 and 2, a reference sign FD represents a direction in which the fluid flows. The fluid is, for example, blood of a cancer patient or a white blood cell differential purified from the blood. The particles contained in the fluid are, for example, living cells such as lymphocytes, red blood cells, and circulating tumor cells (CTC). That is, the particle capturing device 1 can be applied to, for example, fractionating and capturing, and the like of small blood cells such as lymphocytes and red blood cells and larger cells such as circulating tumor cells.

In the following description, the upstream side in a direction FD in which the fluid flows may be simply referred to as “upstream side”. Similarly, the downstream side in the direction FD in which the fluid flows may be simply referred to as the “downstream side”. In addition, in the following description, in a case where the “size” of a particle is described, the “size” refers to the diameter of the particle unless otherwise specified.

As illustrated in FIG. 1, the particle capturing device 1 according to the present embodiment includes, for example, a bottom plate 2, an electrode pair 3, a capture membrane 4, and a cover member 5.

The bottom plate 2 is an insulator such as a glass plate. The electrode pair 3 is provided on the upper surface of the bottom plate 2. The electrode pair 3 is, for example, a thin-film conductor. The material of electrode pair 3 is, for example, indium tin oxide (ITO).

The electrode pair 3 is, for example, a pair of inter-digitated electrodes with electrodes 31 and 32. A voltage is applied to the electrode pair 3. In the present embodiment, an AC voltage is applied to the electrode pair 3. More specifically, the electrodes 31 and 32 of the electrode pair 3 are electrically connected to one end and the other end of an AC power supply 33, respectively, and the AC voltage is applied between them. The AC voltage applied between the electrodes 31 and 32 is, for example, a sine wave having a frequency of 5 MHz and an amplitude of 0.8 to 3 V. Instead of applying the AC voltage to the electrode pair 3, a DC voltage may be applied. In this case, a DC power supply is provided as the power supply instead of the AC power supply 33. As described above, although the preferred embodiment uses alternating current (AC), even direct current (DC) can be used to capture particles by electrophoresis.

As illustrated in FIG. 2, the electrode 31 of the electrode pair 3 has a base portion 31a extending in the direction FD in which the fluid flows, and a plurality of lines 31b extending from the base portion 31a in a direction orthogonal to the direction FD. Similarly, the electrode 32 of the electrode pair 3 has a base portion 32a extending in the direction FD in which the fluid flows, and a plurality of lines 32b extending from the base portion 32a in a direction orthogonal to the direction FD. The widths of the line 31b and the line 32b are, for example, 40 μm. In the direction FD in which the fluid flows, the line 31b and the line 32b are alternately provided. That is, the line 31b and the line 32b constitute interdigitated electrodes. When the AC power supply 33 is turned on, an AC voltage is applied between the line 31b and the line 32b adjacent in the direction FD in which the fluid flows. The line 31b and the line 32b correspond to a first portion and a second portion in the present embodiment, respectively. As illustrated in FIG. 2, the line 31b and the line 32b adjacent to each other in the direction FD in which the fluid flows are provided apart from each other.

The configuration of the electrode pair 3 is not limited to that illustrated in FIGS. 1 and 2. For example, in the electrode pair 3, at least one of the base portion 31a and the base portion 32a may be a metal foil such as a copper foil connected in parallel to the line 31b and the line 32b, respectively. In addition, instead of at least one of the base portion 31a and the base portion 32a, a wire, a cable, or the like that connects the line 31b and the line 32b and one end and the other end of the AC power supply 33, respectively, in parallel may be provided.

The capture membrane 4 is provided on the electrode pair 3 and covers at least a part of the electrode pair 3. More specifically, the capture membrane 4 is provided on the electrode 31 and the electrode 32, and covers at least a part of the line 31b and the line 32b. The capture membrane 4 is provided along at least one surface of the flow path to capture the particles contained in the fluid flowing in the flow path by dielectrophoresis. In the present embodiment, as described later, the capture membrane 4 is provided along the bottom surface of the fluid channel. The capture membrane 4 is, for example, an insulating film such as a photoresist.

The capture membrane 4 is provided with various wells for capturing the particles. That is, at least one coupling well 41 is formed on the upstream side of the capture membrane 4 in the direction FD in which the fluid flows. As will be described in detail later, the coupling well 41 according to the present embodiment has a so-called skewers dumpling shape in which a plurality of circular first wells 41a are coupled. In addition, in the capture membrane 4, at least one second well 42 is formed on the downstream side of the coupling well 41 in the direction FD in which the fluid flows. The coupling well 41 and the second well 42 include a through hole provided in the capture membrane 4 and the line 31b and the line 32b located on the lower surface of the through hole. Various wells such as the coupling well 41, the first well 41a, and the second well 42 are also called micro-wells. In the present embodiment, as a preferred example, an example in which the coupling wells 41 are disposed on the upstream side of the capture membrane 4 and the second wells 42 are disposed on the downstream side will be described, but the present invention is not limited to this configuration. For example, the arrangement of the second well may be omitted, and the coupling wells 41 may be arranged to constitute the capture membrane 4. Alternatively, the coupling wells 41 having small diameter of the first wells 41a may be arranged on the upstream side, and the coupling wells 41 having large diameter of the first wells 41a may be arranged on the downstream side.

The height, that is, the thickness of the capture membrane 4 is, for example, 3.6 to 4 μm. The height of the capture membrane 4 may be different between the portion where the coupling well 41 is formed and the portion where the second well 42 is formed. As another example, the capture membrane 4 may be divided into a portion where the coupling well 41 is formed and a portion where the second well 42 is formed. As still another example, the capture membrane 4 may have a different height for each portion covering each line, or may be divided for each portion covering each line.

In the present embodiment, the upper surface of one of the line 31b and the line 32b is exposed at the bottom of the coupling well 41. That is, the coupling well 41 is provided on one of the line 31b and the line 32b, and is not provided so as to straddle the line 31b and the line 32b. Similarly, the upper surface of one of the line 31b and the line 32b is exposed at the bottom of the second well 42. That is, the second well 42 is provided on one of the line 31b and the line 32b, and is not provided so as to straddle the line 31b and the line 32b. As a result, the coupling well 41 and the second well 42 can be easily formed, and it is also possible to form the coupling well 41 and the second well 42 smaller than the inter-width of electrode pairs 3.

In the present embodiment, the plurality of coupling wells 41 are shifted in the direction orthogonal to the direction FD for each line. For example, in FIG. 2, the coupling wells 41 on the line 32b are shifted from the coupling wells 41 on the adjacent line 31b in the direction orthogonal to the direction FD in which the fluid flows. As described above, the coupling wells 41 (first coupling wells) located on the downstream side are shifted from the coupling wells 41 (second coupling wells) located on the upstream side in the direction (a second direction) orthogonal to the direction FD (a first direction) in which the fluid flows. As a result, particles that cannot be captured by the coupling wells 41 on a certain line are easily captured by the coupling wells 41 on other lines, so that the capture efficiency of the coupling wells 41 can be improved. Similarly, the second well 42 located on the downstream side is shifted from the second well 42 located on the upstream side in the direction orthogonal to the direction FD in which the fluid flows. As a result, the capture efficiency of the second wells 42 can be improved. In the present embodiment, as a preferred example, an example in which the coupling wells 41 are shifted in a direction orthogonal to the direction FD in which the fluid flows and arranged in an inclined direction will be described, but the present invention is not limited to this configuration. For example, the arrangement direction of the coupling wells 41 may be a direction along the direction FD or a direction orthogonal to the direction FD.

As illustrated in FIG. 1, the cover member 5 is provided so as to cover the capture membrane 4. The cover member 5 is, for example, silicone rubber such as polydimethylsiloxane (PDMS). The cover member 5 includes, for example, a frame portion 51 and a lid portion 52. The frame portion 51 is provided with an opening 53 for forming a fluid channel through which a fluid flows. The lid portion 52 is provided with an opening 54 for an inlet of the fluid channel and an opening 55 for an outlet of the fluid channel. A pump, a syringe, or the like (not illustrated) is connected to at least one of the opening 54 and the opening 55, the fluid flows into the fluid channel through the opening 54, and the fluid is discharged from the fluid channel through the opening 55.

In the example of FIG. 1, the corner portions of the frame portion 51 and the lid portion 52 of the cover member 5 are fixed to the corner portions of the bottom plate 2 by screws or the like. More specifically, the frame portion 51 of the cover member 5 is fixed onto the bottom plate 2, and the lid portion 52 of the cover member 5 is fixed onto the frame portion 51. The cover member 5 may be fixed to the bottom plate 2 with an adhesive or the like. In addition, in the cover member 5, the frame portion 51 and the lid portion 52 may be integrally formed.

### <Details of Coupling Well>

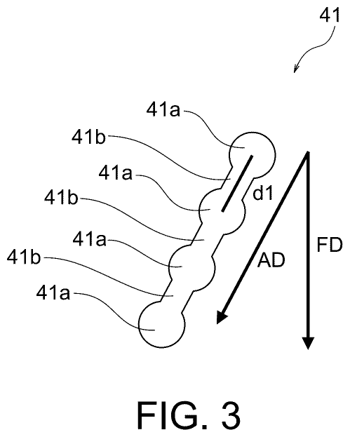

Next, the coupling well 41 according to the present embodiment will be described in more detail with reference to FIG. 3. FIG. 3 is a schematic plan view of the coupling well 41 according to one embodiment.

As illustrated in FIG. 3, the coupling well 41 according to the present embodiment includes a plurality of first wells 41a connected to each other. In the present embodiment, the plurality of first wells 41a are connected to each other by a connection well 41b.

In addition, in the present embodiment, in the coupling well 41, each of the plurality of first wells 41a is circular, and the connection well 41b is rectangular. As described above, the coupling well 41 according to the present embodiment has a skewers dumpling shape in which the first well 41a serves as a dumpling portion and the connection well 41b serves as a skewer portion. At least one of the plurality of first wells 41a may have an elliptical shape or a polygonal shape such as a hexagon or an octagon. In addition, the connection well 41b is not limited to a rectangle, and may have a shape in which the width of the intermediate portion of the connection well 41b is wider or narrower than the width of the portion where the connection well 41b and the first well 41a are in contact with each other.

In the coupling well 41, the size, that is, the diameter of each of the first wells 41a is set to be, for example, equal to or smaller than the size of a first target particle that is a particle targeted to be captured in the coupling well 41. Examples of the first target particle include small single cells such as lymphocytes and red blood cells, and the diameter is set according to the size of the single cells. The first target particle is preferably a single cell such as a lymphocyte or a red blood cell, but may be applied to a cluster comprising at least one of a lymphocyte or a red blood cell. Furthermore, the first target particle may be applied to a cluster consisting of at least one of a lymphocyte or a red blood cell. The size of the particle such as the first target particle can be represented by, for example, the diameter, the major axis, or the minor axis of the particle, but in the present embodiment, the diameter will be described as “size”. If the size of the first target particle is within a certain range, the size of the first well 41a is set to, for example, the lower limit of the range or less. More specifically, the size of the first well 41a may be set to be smaller than the size of the first target particle by about 2 μm. This is because when the size of the first well 41a becomes larger than the size of the first target particle, there is a possibility that a particle having a large diameter different from the particle to be captured is non-specifically captured. By setting the size of the first well 41a to a size smaller than the size of the first target particle by a certain ratio (for example, about 20%), particles having a larger diameter are not captured, but particles are able to be captured in a state where the first target particle is put on the first well 41a. On the other hand, the size of the first well 41a is set to be larger than the radius of the first target particle. This is because if the size of the first well 41a is very small, the effect of dielectrophoresis cannot be sufficiently obtained, and a force for capturing the first target particle is not generated. Alternatively, the size of the first well 41a may be determined, for example, from the size of the first target particle and the height of the capture membrane 4 in the portion where the first well 41a is formed. The height of the capture membrane 4 is set to such an extent that a part of the first target particles can be drawn to the inside of the first well 41a while the capturing force can be ensured more strongly as the height is lowered and the distance between the electrode and the first target particles is shortened. In the present embodiment, it is assumed that the size of particles to be captured by the first well 41a is about 8 μm, and the diameter of the first well 41a is 6 μm.

In the present embodiment, in the coupling well 41, the sizes of the plurality of first wells 41a are equal to each other. The size of at least one of the plurality of first wells 41a may be different from that of the other first wells 41a. For example, the size of the first well 41a may gradually increase from one end to the other end of the coupling well 41.

In addition, in the present embodiment, in the coupling well 41, the plurality of first wells 41a are arranged in a direction AD oblique to the direction FD in which the fluid flows. That is, the direction AD in which the plurality of first wells 41a are arranged on the capture membrane 4 obliquely intersects the direction FD in which the fluid flows. The angle formed by the direction AD and the direction FD is, for example, such an angle that, when a first target particle is captured in the first well 41a on the front side, that is, on the upstream side in one coupling well 41, the capture of another first target particle in the first well 41a on the rear side, that is, on the downstream side is not inhibited. Specifically, the angle formed by the direction AD and the direction FD is an angle at which a certain first well 41a and the first well 41a coupled to immediately behind the certain first well are shifted by, for example, a length 0.8 to 1.0 times the diameter of the first well 41a in the direction orthogonal to the direction FD.

The angle by which the direction AD of the axis of the coupling well 41 is inclined with respect to the direction FD that is the flow direction of the fluid will be described. According to the structure of the coupling well 41 in the present embodiment, as will be described later, even if the first well 41a at the head of the flow path fails to capture the first target particle and the first target particle flows downstream, the first target particle can be captured by the subsequent coupled first well 41a, and as a result, the ability of capturing the first target particle is improved. Here, a case where the direction AD of the axis is inclined at an angle of 90 degrees with respect to the direction FD that is the flow direction of the fluid, that is, to an angle orthogonal to the direction FD is considered. At this angle, if any of the first wells 41a of the coupling wells 41 fails to capture the first target particle, the other coupled first wells 41a also fail to exert a capturing force. On the other hand, a case where the direction AD is an angle parallel to the direction FD will be considered. At this angle, the ability of the subsequent first well 41a to capture the first target particle that the first well 41a at the head has missed can be secured. However, in a situation where the first target particle is already captured in the connected first well 41a at the head, even if the second first target particle flows into the same coupling well 41, it cannot flow into the subsequent first well 41a because the first target particle already captured in the first well 41a at the head becomes an obstacle. Therefore, the second and subsequent first target particles cannot be captured in the subsequent coupled first well 41a, and as a result, the capture ability of the series of coupling wells 41 decreases. In addition, in a case where the direction AD is at an angle parallel to the direction FD, the region occupied by the coupling wells 41 with respect to the lateral width direction of the flow path is narrow, and thus the particle capture range with respect to the flow path is also narrow.

For the reasons described above, by inclining the direction AD obliquely with respect to the direction FD, the ability of the series of coupled first wells 41a to capture the first target particles can be enhanced, and the capture range in the lateral width direction of the flow path can also be secured to be wide. Note that it is preferable that the angle inclined with respect to the direction FD is not 45 degrees, but is an angle shifted by a length 0.8 to 1.0 times the diameter of the first well 41a in the direction orthogonal to the direction FD, and the direction AD and the direction FD are inclined at an acute angle. This is because if the first well 41a at the head fails to capture the first target particles with respect to the coupling well 41, the first target particles can be moved so as to be attracted to the axis of the coupling well 41 and cling to the axis by the electrophoretic force generated by the connection well 41b connected to the coupled first well 41a at the head and the subsequent first well 41a. In order to secure a wide range in which the series of coupling wells 41 exert the capture ability with respect to the lateral width direction of the flow path, it is geometrically desirable to make the direction in which the direction AD is inclined obtuse at the expense of the ability to re-capture the lost first target particle. However, since there is the above-described force to attract the first target particle, by setting the angle at which the direction AD and the direction FD form an acute angle, it is possible to secure the ability to re-capture the lost first target particle while securing the range in which the series of coupling wells 41 exert the capture ability with respect to the lateral width direction of the flow path. Note that the angle formed by the direction AD and the direction FD is not limited to the above range, and can be set to various values.

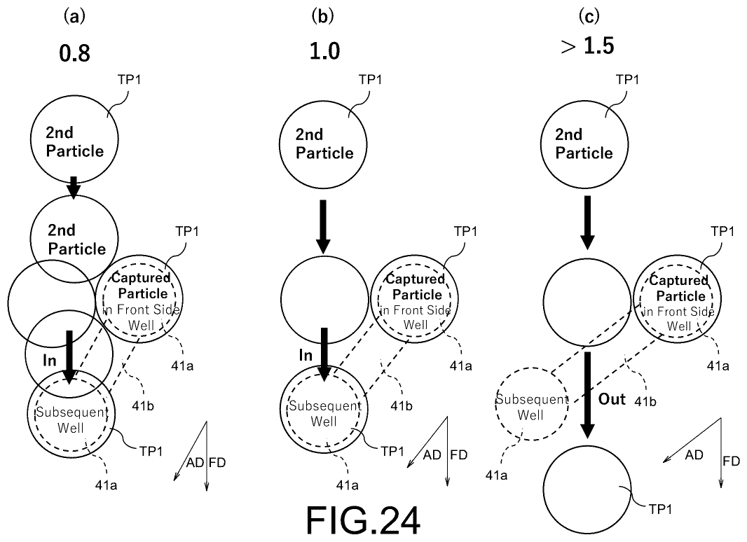

Here, with reference to FIG. 24, the angle by which the direction AD is inclined with respect to the direction FD will be described in more detail. FIG. 24 is a diagram illustrating a relationship between the direction AD of the axis of the coupling well 41 according to one embodiment and an ability to capture the first target particles TP1 of the coupling well 41. More specifically, in FIG. 24, (a) illustrates how the first target particles TP1 are captured by the first wells 41a when the angle is set such that the adjacent first wells 41a are shifted by an angle such that they are displaced by a length 0.8 times the diameter of the first well 41a. (b) illustrates how the first target particles TP1 are captured by the first wells 41a when the angle is set such that the adjacent first wells 41a are shifted by an angle such that they are displaced by a length 1.0 times the diameter of the first well 41a. (c) illustrates how the first target particles TP1 are captured by the first wells 41a when the angle is set such that the adjacent first wells 41a are shifted by an angle such that they are displaced by a length greater than 1.5 times the diameter of the first well 41a.

As illustrated in FIG. 24, by making the direction AD and the direction FD form an acute angle, it is considered that at least the following three advantages can be obtained. First, 1) the number of installed coupling wells 41 can be increased. More specifically, if the coupling wells 41 are too close to each other, problems such as particles other than the first target particles TP1 being captured between the first target particles TP1 captured on adjacent coupling wells 41 may occur, so a certain distance is necessary between the coupling wells 41. By making the direction AD and the direction FD form an acute angle, it can be easier to secure this distance. Note that, in this embodiment, the plurality of coupling wells 41 are arranged such that particles flowing in the fluid pass over at least one coupling well 41 while passing over the two lines 31b and 32b. In addition, 2) by making the direction AD and the direction FD form an acute angle, the first target particles TP1 become easier to move along the coupling well 41, as will be described later. As a result, the capture efficiency of the coupling well 41 can be improved. On the other hand, 3) when the angle between the direction AD and the direction FD is too small, if a first target particle TP1 is captured by the first well 41a on the front side of a coupling well 41, it becomes difficult for other first target particles TP1 to be captured by the first well 41a on the rear side.

Although it depends on conditions such as flow velocity, voltage, well height, under the conditions of this embodiment, as illustrated in FIG. 24(a), a next first target particle TP1 (2^{nd} Particle) flows so as to collide with an already captured first target particle TP1 (Captured Particle). At this time, the next first target particle TP1, while remaining in contact with (clinging to) the already captured first target particle TP1, moves slightly behind the already captured first target particle TP1. Thereafter, the next first target particle TP1 detaches from the already captured first target particle TP1 and is carried downstream. The position where the next first target particle TP1 clings to the already captured first target particle TP1 in this manner is around 20% of the diameter of the first target particle TP1. Therefore, it is considered effective to set the angle by which the direction AD is inclined with respect to the direction FD such that the adjacent first wells 41a are shifted by a length of 0.8 times or more the diameter of the first well 41a in a direction perpendicular to the direction FD. On the other hand, as illustrated in FIG. 24(c), when the angle becomes such that the adjacent first wells 41a are shifted by a length greater than 1.0 times the diameter of the first well 41a (for example, shifted by a length greater than 1.5 times), the probability that a first target particle TP1 flowing over the space between two first wells 41a is captured decreases even when the first target particle TP1 passing over the coupling well 41, and the capture efficiency of the coupling well 41 may decrease. Therefore, in this embodiment, the angle by which the axial direction AD of the coupling well 41 is inclined with respect to the direction FD is set such that the adjacent first wells 41a are shifted by a length of 0.8 times or more and 1.0 times or less the diameter of the first well 41a in the direction perpendicular to the direction FD.

Referring back to FIG. 3, in the present embodiment, the width of the connection well 41b is smaller than the size of each of the first wells 41a. Here, the width of the connection well 41b is the length of the connection well 41b in the direction orthogonal to the direction AD. In the present embodiment, the width of the connection well 41b is 3 μm.

Since the connection wells 41b are provided, a distance d1 between the centers of the adjacent first wells 41a is larger than the size of each of the first wells 41a. The distance d1 is set to be equal to the size of the first target particle targeted to be captured by the coupling well 41, for example. If the sizes of the first target particles are over a certain range, the distance d1 is set to be equal to, for example, the upper limit of the range. In the present embodiment, the distance d1 is 8 μm.

In the above example, the coupling well 41 has four first wells 41a. The present invention is not limited thereto, and the number of first wells 41a included in the coupling well 41 may be three or less, or may be five or more. By increasing the number of first wells 41a included in the coupling well 41, the number of first target particles captured by the particle capturing device 1 can be increased. However, the number of the first wells 41a included in the coupling well 41 is, for example, such that the coupling well 41 does not protrude from the line 31b or the line 32b of the electrode pair 3, or such that the coupling well 41 fits in the central portion of the line 31b or the line 32b where the electric field is relatively uniform.

In addition, in the above example, in the coupling well 41, the plurality of first wells 41a are linearly arranged. The present invention is not limited thereto, and in the coupling well 41, the plurality of first wells 41a may be arranged in a curved line or may be arranged so as to be bent in the middle. For example, in the coupling well 41 illustrated in FIG. 3, the first well 41a in the first half may be inclined to the left side with respect to the drawing, and the first well 41a in the second half may be inclined to the right side with respect to the drawing to form the “V”-shaped coupling well 41. Alternatively, in a case where the first wells 41a are provided in a plurality of columns, the first wells 41a of a certain column may be inclined to the left side in FIG. 3, and the first wells 41a of another column may be inclined to the right side in FIG. 3. However, it is preferable to configure such that the first wells 41a of any column are inclined to the same side so that particles that cannot be captured by the first wells 41a of a certain column can be captured by the first wells 41a of the subsequent column.

### <Details of Second Well>

As illustrated in FIG. 2, the second well 42 is a single circular well. The size of the second well 42, that is, the diameter is larger than the size of each of the plurality of first wells 41a. The size of the second well 42 is set to be, for example, equal to or larger than the size of a second target particle targeted to be captured by the second well 42 and equal to or smaller than twice the size of the second target particle. As a result, it is possible to suppress two or more second target particles from being captured in one second well 42. The second target particle is, for example, circulating tumor cells or a cluster comprising circulating tumor cells. In the present embodiment, the diameter of the second well 42 is 12 μm. In addition, the distance between the second wells 42 is larger than, for example, the distance d1 between the centers of the adjacent first wells 41a in the coupling well 41. In the present embodiment, the distance between the second wells 42 is 50 μm. The second wells 42 may have an elliptical shape or a polygonal shape such as a hexagon or an octagon. In addition, the diameter of the second well 42 may be any within the range of 10 to 22 μm.

<additional Explanatory Notes Regarding Sizes of First Well and Second Well>

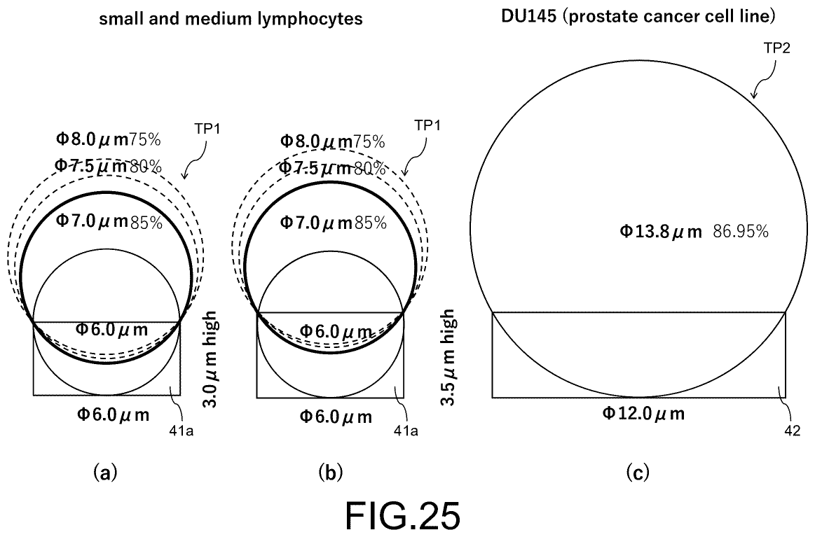

Here, with reference to FIG. 25, the sizes of the first well 41a and the second well 42 will be additionally explained. FIG. 25 is a diagram illustrating a relationship between the sizes of the first well 41a and the second well 42 and sizes of target particles according to one embodiment. More specifically, in FIG. 25, (a) is a diagram illustrating a relationship between a first well 41a having a diameter of 6.0 μm and a height of 3.0 μm, and various first target particles TP1 (small and medium lymphocytes). (b) is a diagram illustrating a relationship between a first well 41a having a diameter of 6.0 μm and a height of 3.5 μm, and various first target particles TP1. (c) is a diagram illustrating a relationship between a second well 42 having a diameter of 12.0 μm and a height of 3.5 μm, and a second target particle TP2 (DU145).

As illustrated in (a) to (c) of FIG. 25, in this embodiment, the first well 41a and the second well 42 are provided so that the heights of the first well 41a and the second well 42 are respectively smaller than the diameters of the first target particle TP1 and the second target particle TP2 (for example, both heights being approximately 3.5 μm). This differs from conventional wells where the first target particle TP1 and the second target particle TP2 can be respectively contained within the first well 41a and the second well 42. As a result, in this embodiment, the upper surface of the electrode pair 3 and the flow channel FD are closer to each other. Therefore, the first target particle TP1 and the second target particle TP2 can be captured using low voltage dielectrophoresis, and single cells or single clusters can be easily captured. In addition, the size of the first well 41a and of the second well 42 can be reduced. However, if the height of the first well 41a and of the second well 42 is set too small, the dielectrophoretic forces acting on each of the captured first target particle TP1 and second target particle TP2 make it difficult to maintain capture, so a certain height is necessary. For example, when the first target particle TP1 is a lymphocyte with an average diameter of 7 μm and the second target particle TP2 is a DU145 with an average diameter of 13.8 μm, the height of both the first well 41a and the second well 42 needs to be approximately 3.5 μm. Note that the height of approximately 3.5 μm is a suitable depth for such lymphocyte and DU145, and the height of the capture membrane 4 is arbitrary. That is, the height of the capture membrane 4 may be adjusted according to the size of the target particles.

The optimal height of wells (i.e., the height of the capture membrane 4) depends on, for example, flow velocity, voltage, target particle size, and post-trap purpose (e.g., whether collection of the particles is needed). In addition, when a captured particle slightly protrudes from the well surface, the smaller the target particles, the more likely that their flow velocity will be reduced by the captured particle, and thus, that they will be captured in the well. In addition, since one of the purposes of the particle capturing device 1 is to capture CTCs (for example, ovarian cancer CTCs) in the second well 42 on the downstream side of the device, the height of the second well 42 needs to be 3.0 to 3.6 μm. More specifically, the height of 3.0 to 3.6 μm is required for the following reasons 1) to 3). Namely, 1) CTCs are captured using the second well 42 downstream from the coupling well 41. However, 2) in view of forming the capture membrane 4, the height of each the first wells 41a of the coupling well 41 and the height of the second well 42 is preferable to be the same. Therefore, 3) 3.0 to 3.6 μm is selected as a diameter that allows both lymphocytes with a diameter of 7 μm and CTCs with a diameter of 13.8 μm to sit on the upper part of these wells, and as a height that ensures sufficient dielectrophoretic force.

To capture small and medium lymphocytes (diameter 5.7 to 8 μm, average diameter 7 μm, average major diameter approximately 7.5 μm) under these conditions, in this embodiment, the diameter size of each first well 41a of the coupling well 41 is set to 6 μm, and the length of the connection well 41b is set to 2 μm. Therefore, the diameter of the first well 41a becomes approximately 80% of the average diameter of the first target particle TP1. The manner in which lymphocytes of each size are captured in the first wells 41a is illustrated in (a) and (b) of FIG. 25. However, in practice, in the first well 41a and the second well 42, corner portions on the flow channel side may have a slightly rounded shape. Therefore, for example, the flow channel side of the first well 41a may become larger in size compared to the examples (a) and (b) of FIG. 25, and a lymphocyte may be captured more toward the electrode side (more toward the bottom side in FIG. 25).

### <Operation of Particle Capturing Device>

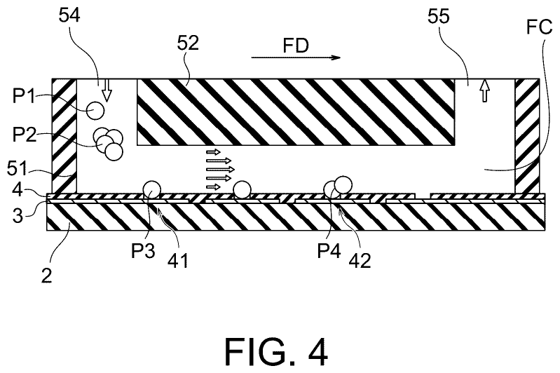

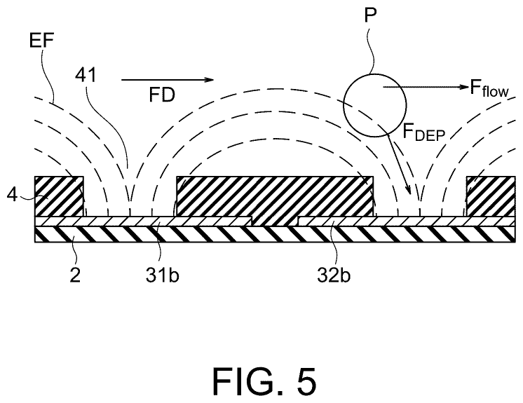

Next, an operation example of the particle capturing device 1 will be described with reference to FIGS. 4 and 5. FIG. 4 is a cross-sectional view illustrating an operation example of the particle capturing device 1 according to one embodiment. FIG. 5 is an enlarged view illustrating an operation example of the particle capturing device 1 according to one embodiment, and is an enlarged view of the periphery of the coupling well 41.

As illustrated in FIG. 4, in the particle capturing device 1 according to the present embodiment, a fluid channel FC through which a fluid flows is defined by the electrode pair 3, the capture membrane 4, and the cover member 5. More specifically, the electrode pair 3 and the capture membrane 4 constitute a bottom surface of the fluid channel FC, the frame portion 51 of the cover member 5 constitutes a side surface of the fluid channel FC, and the lid portion 52 of the cover member 5 constitutes an upper surface of the fluid channel FC. In addition, the opening 54 and the opening 55 of the cover member 5 constitute an inlet and an outlet of the fluid channel FC, respectively.

The fluid contains, for example, particles P1 to P4. For example, the particle P1 is a single cell released in the fluid, the particle P2 is a cell cluster released in the fluid, the particle P3 is a single cell captured in the coupling well 41, and the particle P4 is a cell cluster captured in the second well 42.

As illustrated in FIG. 5, if an AC voltage is applied between the line 31b and the line 32b, an electric field EF is formed between the line 31b and the line 32b. This electric field EF gives a dielectrophoretic force F_{DEP} to the particles P in the fluid. If a sufficient dielectrophoretic force F_{DEP} is applied, the particles P resist the fluid flow force F_{flow} acting on the particles P, and are absorbed and captured by various wells such as the coupling well 41. As described above, the particle capturing device 1 captures the particles contained in the fluid flowing in the flow direction FD into various wells by dielectrophoresis.

### <Target Particles to be Captured>

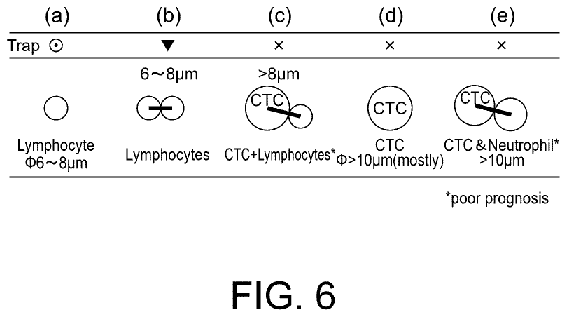

Next, with reference to FIG. 6, the first target particle targeted to be captured by the coupling well 41 and the second target particle targeted to be captured by the second well 42 will be described in more detail.

FIG. 6 is a diagram illustrating an example of target particles in the particle capturing device 1 according to one embodiment. In FIG. 6, (a) represents lymphocyte. The size of this lymphocyte is 6 to 8 μm. (b) is a cluster of two lymphocytes, and the distance between the centers of the lymphocytes is 6 to 8 μm. (c) is a cluster of one lymphocyte and one circulating tumor cell (CTC), the distance between the centers of which is greater than 8 μm. (d) represents a single circulating tumor cell. The size of circulating tumor cells is generally greater than 10 μm. (e) is a cluster consisting of circulating tumor cells and neutrophil, and the distance between their centers is greater than 10 μm. The clusters illustrated in (c) and (e) are correlated with patient's poor prognosis.

In FIG. 6, the row of “Trap” represents whether or not these particles are captured by the coupling well 41. The particles of the type denoted by □ can be well captured, and a certain capture ability is exhibited even for the particles of the type denoted by ▾. On the other hand, the capture ability is not exhibited for particles of the type marked with ×. That is, the lymphocytes in (a) can be well captured in the coupling well 41, and the cluster including the two lymphocytes in (b) can also be captured in the coupling well 41. On the other hand, as illustrated in (c) to (e), a single circulating tumor cell and a cluster containing the circulating tumor cell are hardly captured by the coupling well 41. That is, in the present embodiment, the particles (a) and (b) are an example of the first target particles targeted to be captured by the coupling well 41. Note that at least some of the particles (c) to (e) are an example of the second target particles targeted to be captured by the second well 42. That is, by using the structure of the coupling well 41, particles having a particle size to be captured can be selectively and efficiently captured, and particles having a size larger than the target size can flow downstream without being captured.

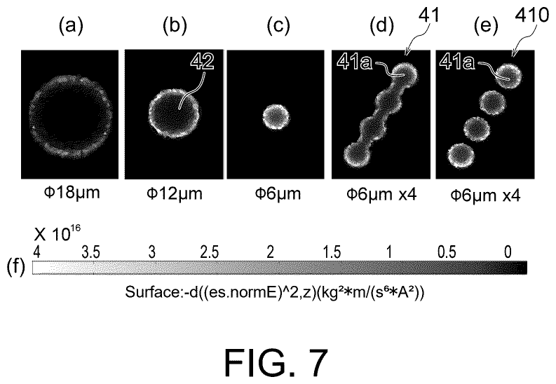

Hereinafter, the point that the coupling well 41 can selectively capture particles having a desired size will be described with reference to FIGS. 7 to 18.

### <Electric Field Formed in Various Wells>

First, in order to clarify the effect in capturing particles in various wells, the results of comparative simulation analysis on the magnitude of the gradient of electric field intensity performed using software COMSOL Multiphysics (registered trademark) will be described. The magnitude of the gradient of the electric field intensity is proportional to the dielectrophoretic force directly acting on the particle capture. More specifically, the dielectrophoretic force per unit area acting on the particles is proportional to the gradient of the square of the electric field intensity (∇E²). The simulation results are illustrated in FIG. 7.

FIG. 7 is a view illustrating simulation results of electric fields formed in various wells in the particle capturing device according to one embodiment and a comparative example. In FIG. 7, (a), (b) and (c) represent an example of an electric field formed in a single and circular well having a diameter of 18 μm, 12 μm and 6 μm, respectively. Among them, (b) corresponds to the second well 42 of the present embodiment. (d) represents an example of the electric field formed in the coupling well 41 according to the present embodiment. (e) represents an example of the electric field formed in an uncoupling well 410 according to the comparative example. The uncoupling well 410 has a plurality of first wells 41a that are not connected to each other. That is, the uncoupling well 410 is a well having a dumpling portion but not having a skewer portion. In the example of (e) in FIG. 7, the diameters of each of the first wells 41a of the uncoupling well 410 are all 6 μm. In addition, the distance between the centers of the adjacent first wells 41a in the uncoupling well 410 is 8 μm, which is the same as that of the coupling well 41. (f) represents the relationship between the density and the electric field intensity in (a) to (e).

As illustrated in (a) to (c) in FIG. 7, in the single and circular well, the gradient of the electric field intensity per unit area increases as the size of the well, that is, the diameter decreases. Therefore, in a case where a small size well is provided alone as in (c), the dielectrophoretic force is excessive, and there is a possibility that particles larger than the target particles may be non-specifically captured in the well.

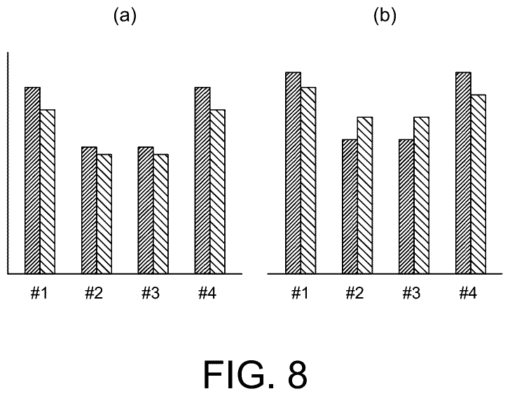

On the other hand, as illustrated in (d) and (e) of FIG. 7, by providing a plurality of single wells at a high density, the magnitude of the electric field intensity in each single well is suppressed. Further, as illustrated in (d) of FIG. 7, by connecting the single wells to each other by the connection well, the electric field intensity is entirely suppressed and equalized. Hereinafter, the electric field intensities of the coupling well 41 and the uncoupling well 410 will be described in more detail with reference to FIG. 8.

FIG. 8 is a graph illustrating the magnitude of the gradient of the electric field intensity formed on each first well 41a in the coupling well 41 according to one embodiment and the uncoupling well 410 according to the comparative example. (a) represents the sum of the electric field intensities of the coupling well 41 and the uncoupling well 410 on each of the first wells 41a. More specifically, the sum is calculated by performing area integration of the electric field intensity at each position. (b) represents the sum of the electric field intensities in a circle having a diameter of 8 μm centered on each first well 41a, that is, in the lymphocyte region. In both of (a) and (b), the lightly hatched graph represents the case of the coupling well 41, and the darkly hatched graph represents the case of the uncoupling well 410. Further, in both of (a) and (b), the sum of the electric field intensities at a position of 4.1 μm in height from the upper surface of the electrode pair 3 is represented. In addition, #1 to #4 represent the sum of the electric field intensities centered on the first well 41a positioned at the first to fourth positions from the upstream side, respectively.

As illustrated in FIG. 8(a), at any position of #1 to #4, the sum of the electric field intensities on the first well 41a in the coupling well 41 is smaller than the sum of the electric field intensities on the first well 41a in the uncoupling well 410. In addition, the sum of the electric field intensities greatly differs at the positions of #1 and #4 at both ends from the positions of #2 and #3 at the central portion. That is, in the coupling well 41, the difference in electric field intensity between both ends and the central portion is smaller than that in the uncoupling well 410, and it can be said that the electric field intensity is equalized.

As illustrated in FIG. 8(b), at the positions of #1 and #4 at both ends, the sum of the electric field intensities in the lymphocyte region in the coupling well 41 is smaller than the sum of the electric field intensities in the lymphocyte region in the uncoupling well 410, as described above. On the other hand, at the positions of #2 and #3 in the central portion, the sum of the electric field intensities of the coupling well 41 is larger than that of the uncoupling well 410. This is because in the coupling well 41, a part of the connection well 41b exists in the lymphocyte region, and the electric field intensity in the connection well 41b is added. Therefore, it can be said that the electric field intensity in the lymphocyte region is more equalized in the coupling well 41.

As described above, according to the coupling well 41, the magnitude of the gradient of the entire electric field intensity can be suppressed as compared with the single well and the uncoupling well 410, and the electric field equalized at both ends and the central portion can be formed as compared with the uncoupling well 410.

### <Capturing Experiment of Second Target Particles>

Next, the fact that the coupling well 41 according to the present embodiment can suppress non-specific capture of the second target particles as compared with the uncoupling well 410 according to the comparative example will be described.

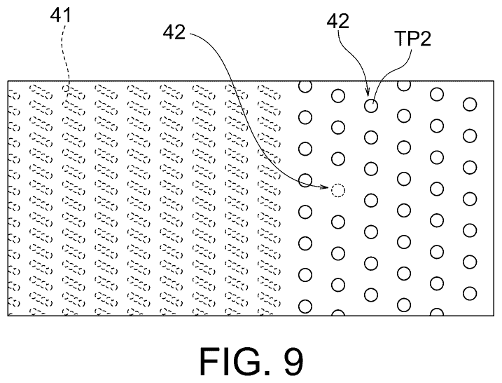

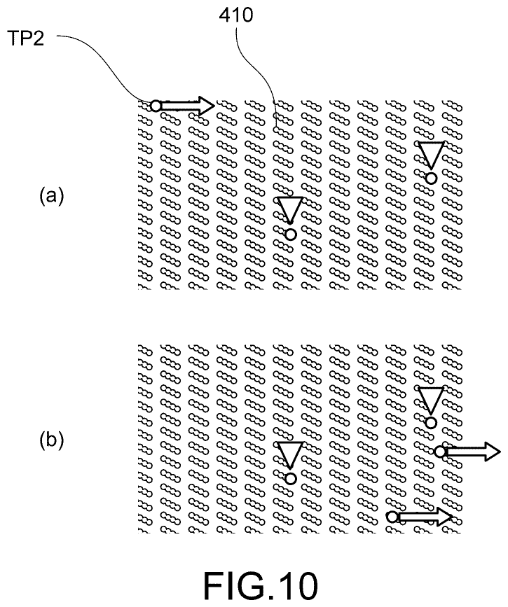

FIG. 9 is a diagram illustrating results of capturing experiment of second target particles TP2 in the particle capturing device 1 according to one embodiment. In FIG. 9, the coupling well 41 and the second well 42, which are indicated by dotted lines, represent wells in which the second target particle TP2 is not captured, and the second well 42 indicated by solid lines represents wells in which the second target particle TP2 is captured. FIG. 10 is a diagram illustrating results of capturing experiment of second target particles TP2 in the particle capturing device according to the comparative example. In FIG. 10, an uncoupling well 410 indicated by a solid line represents a well in which the second target particle TP2 is not captured. An inverted triangle indicates that the second target particle TP2 is captured below the inverted triangle, and an arrow indicates a moving direction of the second target particle TP2 that is not captured. FIG. 10(a) illustrates a state at time 0 seconds, and FIG. 10(b) illustrates a state at time 7 seconds.

In the capturing experiment of FIGS. 9 and 10, DU145 cells (prostate cancer cell line) were used as the second target particle TP2. The DU145 cells have a diameter of 10 μm or more and an average diameter of 13 μm.

As illustrated in FIG. 9, it can be seen that the DU145 cells, which are the second target particles TP2, are not captured by the coupling well 41, but are captured by the second well 42 provided downstream of the coupling well 41.

On the other hand, as illustrated in FIG. 10, it can be seen that some DU145 cells are non-specifically captured in the uncoupling well 410. As compared with the coupling well 41 capable of forming an equalized electric field, in the uncoupling well 410, the electric field intensity is large and the electric field is non-uniform in the first well 41a at both ends. Therefore, it is considered that this is because a region having a high dielectrophoretic force locally occurs, and the first well 41a non-specifically captures even the second target particle TP2 that is not originally the capture target.

Therefore, in the coupling well 41, since a uniform electric field can be formed by providing the coupling portion, it is possible to suppress non-specific capture of the second target particles TP2 as compared with the uncoupling well 410.

### <Capturing Experiment of First Target Particles>

Next, the fact that the coupling well 41 according to the present embodiment can improve the capture efficiency of the first target particles as compared with the uncoupling well 410 according to the comparative example will be described.

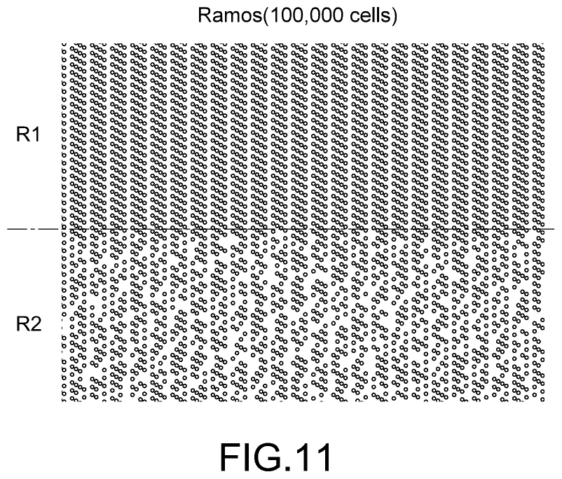

FIG. 11 is a diagram illustrating results of an experiment for capturing first target particles in the coupling wells 41 according to one embodiment and the uncoupling wells 410 according to the comparative example. Each circle in FIG. 11 represents the captured first target particle.

In the capturing experiment of FIGS. 11, 100,000 Ramos cells (lymphoid blood cells) were used as the first target particles. The diameter of the Ramos cells is 5.4 μm to 12.5 μm and the average diameter is 6.9 μm. In this capturing experiment, a particle capturing device in which a plurality of coupling wells 41 and a plurality of uncoupling wells 410 were arranged at a ratio of 1:1 was used. More specifically, the coupling wells 41 are provided in an upper region R1 in FIG. 11, and the uncoupling wells 410 are provided in a lower region R2. As illustrated in FIG. 11, it can be seen that more Ramos cells are captured in the coupling wells 41 than in the uncoupling wells 410.

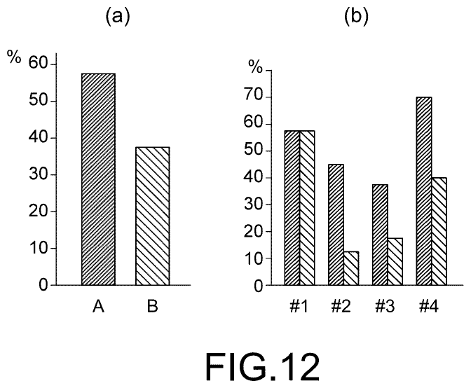

FIG. 12 is a graph illustrating results of an experiment for capturing first target particles in the coupling well 41 according to one embodiment and the uncoupling well 410 according to the comparative example, and is an aggregation of the results of FIG. 11. FIG. 12 illustrates results of comparing the number of captured Ramos cells when the particle capturing rate in the coupling wells 41 exceeds 50%. FIG. 12(a) illustrates the ratio of the first target particles captured in the coupling well 41 and the uncoupling well 410, respectively. In FIG. 12(a), a symbol A represents the ratio captured by the coupling well 41, and a symbol B represents the ratio captured by the uncoupling well 410. FIG. 12(b) illustrates the ratio of the first target particles captured in each of the first wells 41a at positions #1 to #4 for each of the coupling well 41 and the uncoupling well 410. In FIG. 12(b), the darkly hatched graph represents the case of the coupling well 41, and the lightly hatched graph represents the case of the uncoupling well 410.

As illustrated in FIG. 12(a), it can be seen that more Ramos cells are captured in the coupling wells 41 than in the uncoupling wells 410. More specifically, the number of Ramos cells captured in the coupling well 41 is 1.5 times or more the number of Ramos cells captured in the uncoupling well 410. That is, it can be seen that the capture efficiency is 1.5 times or more higher in the coupling well 41 than in the uncoupling well 410.

In addition, as illustrated in FIG. 12(b), in the coupling well 41, the difference in the capture rate between the first well 41a located at #2 and #3 at both ends and the first well 41a located at #2 and #3 in the central portion is small, and it can be seen that the capture efficiency of Ramos cells in the central portion is significantly increased as compared with that of the uncoupling well 410. This is considered to be because in the coupling well 41, the magnitude of the gradient of the electric field intensity in the lymphocyte region in the first well 41a in the central portion increases.

As described above, in the coupling well 41, the capture efficiency of the first target particles can be improved as compared with the uncoupling well 410.

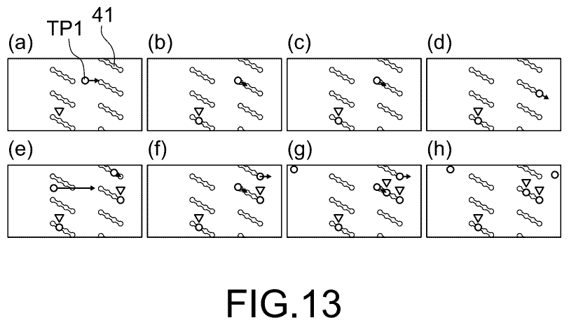

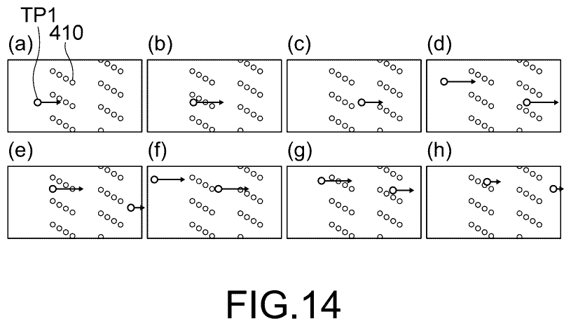

In addition, in the coupling well 41, the first target particles released without being completely captured in the first well 41a on the upstream side are captured again in the first well 41a on the downstream side along the connection well 41b, and the capture efficiency is further improved. This will be described with reference to FIGS. 13 and 14.

### <Recapture of First Target Particles in Coupling Well>

FIG. 13 is a diagram illustrating results of another experiment for capturing first target particles TP1 in the coupling well 41 according to one embodiment. FIG. 14 is a diagram illustrating results of another experiment for capturing first target particles TP1 in the uncoupling well 410 according to the comparative example. FIGS. 13 and 14 illustrate time-lapse images captured in the order of (a) to (h), respectively. In addition, in FIGS. 13 and 14, an inverted triangle indicates that the first target particle TP1 is captured below the inverted triangle, and an arrow indicates a moving direction of the first target particle TP1 that is not captured.

In the capturing experiment of FIGS. 13 and 14, Ramos cells were used as the first target particles TP1, similarly to the capturing experiment of FIG. 11. Similarly, a particle capturing device in which a plurality of coupling wells 41 and a plurality of uncoupling wells 410 were arranged at a ratio of 1:1 was used. On the other hand, in this experiment, the AC voltage applied to the electrode pair 3 was decreased by 1 V from that in the capturing experiment of FIG. 11, and the flow rate of the fluid was increased by 0.3 μl/min, so that the condition that the particles were hardly captured was set.

As illustrated in (a) of FIG. 13, when the Ramos cell as the first target particle TP1 approaches the coupling well 41, the particle moves in a sawtooth shape along the coupling well 41 as illustrated in (b) to (d). When moving along the coupling well 41, the moving speed of the particle decreases. Thereafter, as illustrated in (e), the particle is captured in the first well 41a on the downstream side of the coupling well 41. That is, although the particles are not sufficiently captured in the first well 41a on the upstream side, the particles move along the coupling well 41 and are captured again in the first well 41a on the downstream side. Thereafter, as illustrated in (e) to (h), when other Ramos cells approach the coupling well 41, the particle similarly moves along the coupling well 41 and is captured by the first well 41a on the downstream side.

On the other hand, as illustrated in (a) to (h) of FIG. 14, even if the Ramos cells as the first target particles TP1 approach the uncoupling well 410, the above behavior is not exhibited. That is, the moving direction of the first target particle TP1 does not greatly change from the direction FD in which the fluid flows, and does not move along the uncoupling well 410. Therefore, in the uncoupling well 410, the particles move linearly between the uncoupling wells 410, and it can be seen that the capture efficiency is lower than that of the coupling well 41.

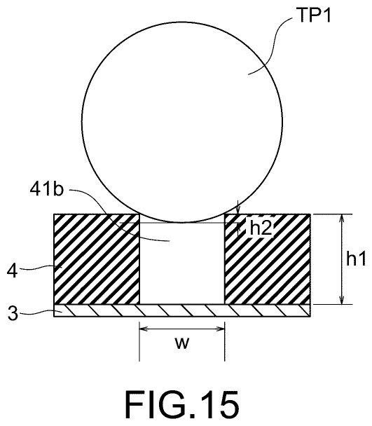

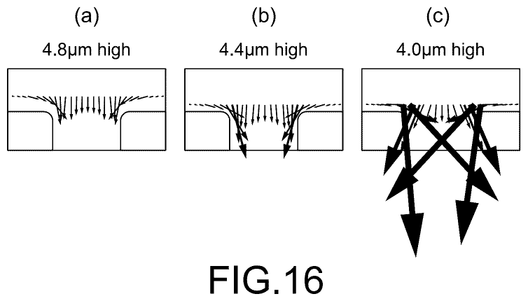

The fact that particles approaching the coupling well 41 under dielectrophoresis exhibit the above behavior will be described with reference to FIGS. 15 and 16. FIG. 15 is a view illustrating a state of the first target particles TP1 on the connection well 41b in the coupling well 41 according to one embodiment. FIG. 16 is a view illustrating a state of electric fields on the connection well 41b in the coupling well 41 according to one embodiment. In FIG. 16, each arrow represents an electric field formed at a respective distance from the electrode pair 3.

As illustrated in FIG. 15, the connection well 41b has a height h1 and a width w. The height h1 is the height of the capture membrane 4 at the portion where the connection well 41b is formed. When the first target particle TP1 is located on the connection well 41b, the lower end of the first target particle TP1 is located below the upper surface of the capture membrane 4 by the height h2. That is, the lower end of the first target particle TP1 is closer to the electrode pair 3 by the height h2 than the upper surface of the capture membrane 4. As a specific example, assuming that the diameter of the first target particle TP1 is 5.5 to 8.5 μm, the height h2 is 0.3 to 0.4 μm.

As illustrated in FIG. 16, the electric field intensity on the connection well 41b increases significantly as it approaches the upper surface of the electrode pair 3. By providing the connection well 41b, the distance between the first target particle TP1 and the electrode is kept short, and the dielectrophoretic force acting on the first target particle TP1 is kept. As a result, it is considered that the first target particle TP1 is hardly dissociated from the coupling well 41. In the coupling well 41, even if the first target particle TP1 to be captured escapes from being captured by the first well 41a at the head and flows to the downstream side, the particle can be guided to the next coupled first well 41a along the electric field generated by the connection well 41b. Therefore, the ability to capture the first target particle TP1 is improved in the coupling well 41 as compared with the uncoupling well 410.

As described above, in the coupling well 41, the particles can receive the continuous dielectrophoretic force in the connection well 41b as the particles move along the coupling well 41, so that the capture efficiency of the first target particles TP1 can be further improved.

### <Fractionating and Capturing Experiment of First Target Particle and Second Target Particle>

Next, the results of the fractionating and capturing experiment of the first target particle TP1 and the second target particle TP2 using the particle capturing device 1 according to the present embodiment will be described.

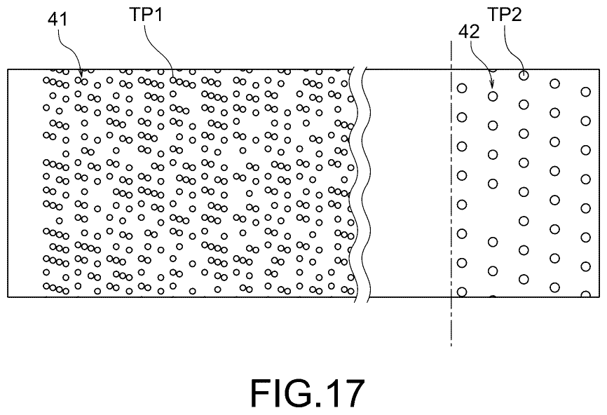

FIG. 17 is a diagram illustrating results of experiment of fractionating and capturing the first target particles TP1 and the second target particles TP2 in the particle capturing device 1 according to one embodiment. Each circle in FIG. 17 represents the captured first target particle TP1 and second target particle TP2.

In the capturing experiment of FIG. 17, Ramos cells were used, similarly to the capturing experiment of FIG. 11. Among the Ramos cells, particles having a diameter of 8.4 μm or less correspond to the first target particle TP1, and the remaining particles correspond to the second target particle TP2. As illustrated in FIG. 17, it can be seen that Ramos cells having different sizes are captured in the coupling wells 41 and the second wells 42.

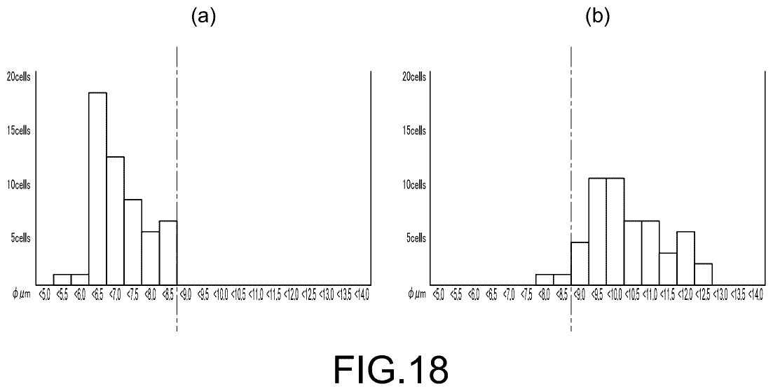

FIG. 18 is a graph illustrating results of experiment of fractionating and capturing the first target particles TP1 and the second target particles TP2 in the particle capturing device 1 according to one embodiment, and is an aggregation of the results of FIG. 17. FIG. 18(a) and 18(b) each represent a histogram obtained by aggregating the Ramos cells captured in the coupling well 41 and the second well 42 for each diameter. In both FIG. 18(a) and 18(b), the number of particles is counted in increments of 0.5μm in diameter, and the left side of the dash-dotted line represents the number of particles having a diameter of 8.4 μm or less.

As illustrated in FIG. 18(a), the Ramos cells having a diameter of 8.4 μm or less are captured in the coupling well 41. The Ramos cells captured in the coupling well 41 had a diameter of 5.4 to 8.4 μm and an average diameter of 6.87 μm. In addition, the Ramos cells captured in the coupling well 41 account for 95% or more of all cells.

On the other hand, as illustrated in FIG. 18(b), the Ramos cells having a diameter of 9.0 μm or more are captured in the second well 42. The Ramos cells captured in the second well 42 had a diameter of 7.6 to 12.1 μm and an average diameter of 10.0 μm.

As described above, according to the particle capturing device 1 of the present embodiment, among the particles contained in the fluid, the Ramos cells having a small size can be selectively captured in the coupling wells 41, and the remaining Ramos cells can be captured in the second wells 42. That is, according to the particle capturing device 1 of the present embodiment, among the particles contained in the fluid, the first target particle TP1 can be selectively captured by the coupling wells 41, and the second target particle TP2 can be selectively captured by the second wells 42.

### <Operation and Effect>

As described above, in the particle capturing device 1 according to the present embodiment, the coupling well formed in the capture membrane 4 has the plurality of first wells 41a connected to each other. This makes it possible to avoid a decrease in the total area of the coupling wells 41 while reducing the size of each of the first wells 41a. Therefore, it is possible to avoid an unnecessary increase in the dielectrophoretic force, and it is possible to suppress non-specific capture. Therefore, according to the particle capturing device 1 of the present embodiment, it is possible to selectively capture particles having a small size among the particles contained in the fluid.

Conventionally, in a case where particles such as cells are divided by size, a filter method of sieving the particles is used. In the filter method, a solution containing particles is drawn at a negative pressure and passed through a filter to capture large particles on the filter and pass small particles under the filter. However, in the filter method, since the particles are deformed by physical compression, it is difficult to perform accurate separation depending on the size of the particles. In addition, even if the target particles include small particles, the target particles are lost.

According to the present embodiment, by capturing the particles contained in the fluid by dielectrophoresis, deformation of the particles at the time of capturing is avoided as compared with the case of using the filter method, and highly accurate separation depending on the size of the particles can be facilitated. In addition, unlike the filter method, even if the target particles include small particles, the target particles can be detected without discarding the target particles.

In addition, since the coupling well 41 has the plurality of first wells 41a, the number of first wells 41a included in the particle capturing device 1 can be increased, and more first target particles TP1 can be captured. This is effective, for example, in a case where most of the particles in the fluid are the first target particles TP1.

In addition, in the coupling well 41, the plurality of first wells 41a are connected to each other by the connection well 41b, whereby the electric field intensity between the first wells 41a is equalized as compared with that between the uncoupling wells 410. More specifically, the dielectrophoretic force is suppressed in the first wells 41a at both ends, and non-specific capture of particles larger than the first target particles TP1 can be further suppressed. On the other hand, in the first well 41a in the central portion, by connecting the connection wells 41b to both ends thereof, the gradient of the electric field intensity is increased, and the capture efficiency of the first target particles TP1 can be increased. Furthermore, the dissociated particles once captured in a certain first well 41a can be captured again in the adjacent first well 41a. Therefore, according to the coupling well 41 according to the present embodiment, the capture efficiency of the first target particles TP1 can be improved in all the first wells 41a as compared with the uncoupling well 410.

In the coupling well 41, it is preferable that the distance d1 between the centers of the adjacent first wells 41a is larger than the size of the first well 41a and does not exceed the diameter of the second target particle TP2. First, in the coupling well 41, since the distance d1 between the centers of the adjacent first wells 41a is larger than the size of the first well 41a, the coupling well 41 can efficiently capture the first target particle TP1 over a certain range of size. That is, when the first target particle TP1 is captured in a certain first well 41a, another first target particle TP1 can be captured in the adjacent first well 41a. In the present embodiment, since the diameter of the first well 41a is 6 μm and the distance d1 is 8 μm, the coupling well 41 can capture particles having a diameter of, for example, 6 μm to 8 μm.

On the other hand, in the coupling well 41, the distance d1 between the centers of the adjacent first wells 41a is set to be shorter than the diameter of the second target particle TP2. For example, the distance d1 between the centers of the first wells 41a is preferably about the same as the size of the first target particle TP1. That is, the distance d1 is smaller than the size of the second target particle TP2. As a result, for example, a cluster including the first target particle TP1 and the second target particle TP2 can be suppressed from being non-specifically captured by the coupling well 41. As a specific example, since the distance between the centers of the heteroclusters of lymphocytes and circulating tumor cells as illustrated in FIG. 6(c) is larger than the distance d1, the heteroclusters are suppressed from being captured by the coupling well 41.

In addition, in the coupling well 41, the plurality of first wells 41a are arranged in a direction AD oblique to the direction FD in which the fluid flows. As a result, the plurality of first target particles TP1 are easily captured with respect to one coupling well 41. For example, when the first target particle TP1 is captured in the first well 41a on the upstream side, another first target particle TP1 goes around the captured first target particle TP1 and is captured in the first well 41a on the rear side. As a result, the capture efficiency of the first target particles TP1 can be further improved. Note that by further reducing the angle formed by the direction FD and the direction AD, the number of the coupling wells 41 that can be installed per unit area in the particle capturing device 1 can be further increased, and the number of the first target particles TP1 that can be captured per unit area can be improved.

In addition, since the size of each of the plurality of first wells 41a is equal to or smaller than the size of the first target particle TP1, the first target particle TP1 is not dropped into the coupling well 41 and is captured so as to be placed on the coupling well 41. As a result, one particle larger than the size of the first well 41a by a certain degree can be captured with respect to one first well 41a, and the particle capture efficiency can be improved. The diameter of the first well 41a may be larger than the diameter of the first target particle TP1 and smaller than twice the diameter of the first target particle TP1. In this case, it is possible to suppress two or more first target particles TP1 from being captured in one first well 41a.

In addition, since the second well 42 is formed on the downstream side of the coupling well 41 in the capture membrane 4, the second target particle TP2 can be selectively captured from the fluid after capturing the first target particle TP1. That is, the particles contained in the fluid can be arrayed for each size. In addition, generally, small particles tend to flow faster in the fluid than large particles. Therefore, by arranging the coupling well 41 for capturing small particles on the upstream side and arranging the second well 42 for capturing large particles on the downstream side, the capture efficiency of the particle capturing device 1 can be improved.

### (First Modification)

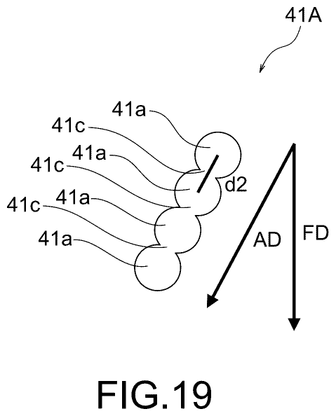

Note that the first wells 41a of the coupling well 41 may be connected to each other without the connection well 41b interposed therebetween. Hereinafter, such a case will be described as the first modification with reference to FIG. 19. FIG. 19 is a schematic plan view of a coupling well 41A according to the first modification of one embodiment.

As illustrated in FIG. 19, the coupling well 41A according to the present modification includes a plurality of first wells 41a connected to each other. In the present modification, the plurality of first wells 41a are connected to each other without the connection well 41b interposed therebetween. A narrow portion 41c having a width narrower than the size of the first well 41a is formed between the plurality of first wells 41a. The width of the narrow portion 41c is, for example, equal to the width of the connection well 41b described above. The distance d2 between the centers of the first wells 41a in the present modification is smaller than the distance d1 between the centers of the first wells 41a in the embodiment.

In the present modification, by connecting the plurality of first wells 41a to each other, it is possible to avoid a decrease in the total area of the coupling wells 41 while reducing the size of each of the first wells 41a. That is, according to the present modification, similarly to the embodiment, it is possible to selectively capture particles having a small size among the particles contained in the fluid.

### (Second Modification)

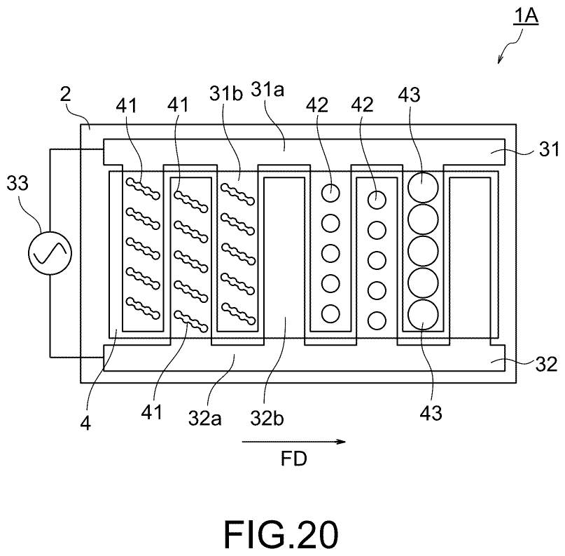

A particle capturing device 1A according to a second modification of one embodiment will be described with reference to FIG. 20. FIG. 20 is a plan view of the particle capturing device 1A according to the second modification of one embodiment. One of the differences between the present modification and the embodiment described above is the presence or absence of a third well 43. Hereinafter, the present embodiment will be described focusing on the differences from the embodiment described above.

As illustrated in FIG. 20, in the present modification, at least one third well 43 is formed on the downstream side of the coupling well 41 in the direction FD in which the fluid flows in the capture membrane 4. Each of the third wells 43 is, for example, a circular single well. In the example of FIG. 20, the plurality of third wells 43 are provided on the downstream side of the second well 42. The third well 43 may be provided on the downstream side of the coupling well 41 and on the upstream side of the second well 42. Alternatively, the third well 43 may be provided on the same line as the second well 42, or may be provided so as to be mixed with the second well 42.

The size of the third well 43, that is, the diameter is larger than the size of each of the plurality of first wells 41a and is different from the size of the second well 42. In the example of FIG. 20, the size of the third well 43 is larger than the size of the second well 42. The size of the third well 43 may be smaller than the size of the second well 42.

According to the present modification, for example, among the second target particles TP2, relatively small particles can be selectively captured in the second well 42, and the remaining particles can be captured in the third well 43. That is, the particles contained in the fluid can be fractionated into more sizes and captured.

### (Third Modification)

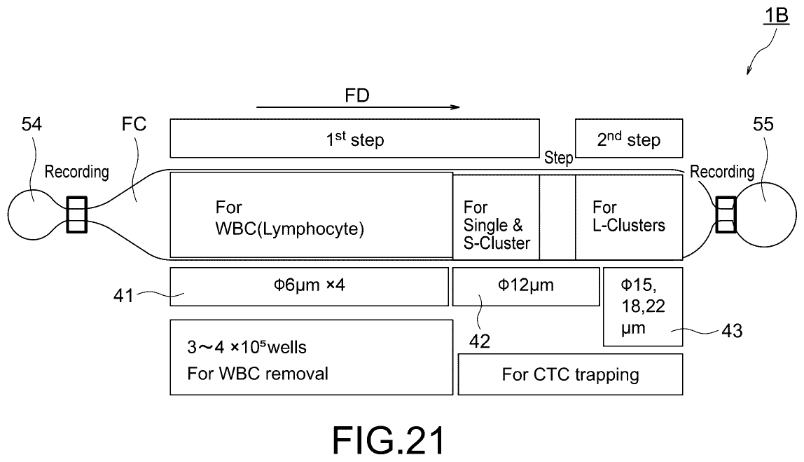

A particle capturing device 1B according to a third modification of one embodiment will be described with reference to FIG. 21. FIG. 21 is a schematic view of the particle capturing device 1B according to the third modification of one embodiment. The present modification has a larger single well in the particle capturing device 1A according to the second modification described above. Hereinafter, the present embodiment will be described focusing on the differences from the second modification.

As illustrated in FIG. 21, the particle capturing device 1B includes a coupling well 41 in which four first wells 41a having a diameter of 6 μm are connected to each other, a second well 42 having a diameter of 12 μm, and a third well 43 having diameters of 15, 18, and 22 μm. Here, the coupling well 41 is for capturing lymphocytes which are a type of white blood cell (WBC), and is provided so that the number of first wells 41a is 3 to 4×10⁵ in total. The second well 42 is for capturing a single circulating tumor cell (CTC) and relatively small clusters containing circulating tumor cells. The third well 43 is for capturing a relatively large cluster including circulating tumor cells.

According to the present modification, the particles contained in the fluid can be fractionated into more sizes and captured. In the well provided in the particle capturing device 1B, the coupling well 41 and the second well 42, which is a single well, are arranged so as to capture small particles on the upstream side and capture large particles on the downstream side. This arrangement is not limited to the combination of the coupling well and the single well as in FIG. 21, and for example, the diameter of the particle to be captured on the upstream side and the diameter of the particle to be captured on the downstream side may be switched by arranging the coupling well 41 having a small diameter of the first well 41a on the upstream side and the coupling well 41 having a large diameter of the first well 41a on the downstream side.

### (Fourth Modification)

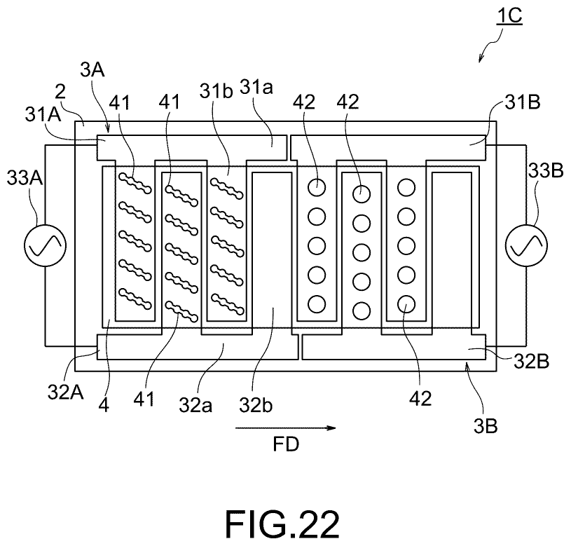

A particle capturing device 1C according to a fourth modification of one embodiment will be described with reference to FIG. 22. FIG. 22 is a plan view of the particle capturing device 1C according to the fourth modification of one embodiment. One of the differences between the present modification and the embodiment described above is the configuration of the electrode pair. Hereinafter, the present embodiment will be described focusing on the differences from the embodiment described above.

As illustrated in FIG. 22, a particle capturing device 1C according to the present modification includes two electrode pairs, that is, an electrode pair 3A and an electrode pair 3B. The electrode pair 3A is provided on the upstream side in the direction FD in which the fluid flows, and the electrode pair 3B is provided on the downstream side. The electrode pair 3A and the electrode pair 3B are electrically connected to an AC power supply 33A and an AC power supply 33B which are different power supplies from each other, respectively. On the electrode pair 3A, while the coupling well 41 is provided, the second well 42 is not provided. In addition, on the electrode pair 3B, while the second well 42 is provided, the coupling well 41 is not provided. The electrode pair 3A and the electrode pair 3B correspond to a first electrode pair and a second electrode pair in the present modification, respectively.

In the present modification, the particles captured in the second well 42 can be released separately from the particles captured in the coupling well 41. For example, after the particles are captured by the coupling well 41 and the second well 42, the AC power supply 33B is turned off to turn off the AC voltage applied to the electrode pair 3B. As a result, the dielectrophoretic force does not act on the particles captured in the second well 42, and the particles captured in the second well 42 can be dissociated and discharged from the outlet by flowing the fluid. On the other hand, since the AC power supply 33A remains on, the captured state of the particles captured by the coupling well 41 is maintained while the fluid flows. Thereafter, the AC power supply 33A is turned off to turn off the AC voltage applied to the electrode pair 3A. As a result, the dielectrophoretic force does not act on the particles captured in the coupling well 41, and the particles captured in the coupling well 41 can be dissociated and discharged from the outlet by flowing the fluid.

According to the present modification, the particles captured in the coupling well 41 and the particles captured in the second well 42 can be separately collected and easily used for subsequent analysis and the like.

Also in the particle capturing device 1 according to the embodiment illustrated in FIG. 2, the particles captured in the second well 42 can be released separately from the particles captured in the coupling well 41. In this case, for example, by cutting the vicinity of the center of the base portion 31a and the base portion 32a into two on the upstream side and the downstream side with a laser or the like while applying the AC voltage, the electrical connection between the line 31b and the line 32b where the second well 42 is located and the AC power supply 33 is disconnected.

### (Fifth Modification)

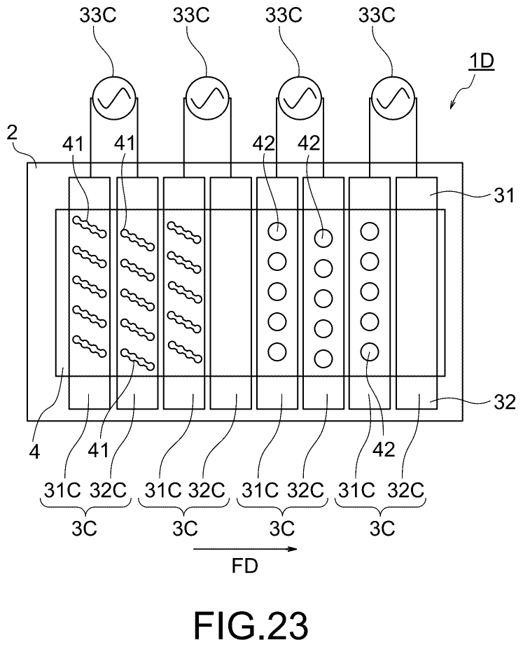

A particle capturing device 1D according to a fifth modification of one embodiment will be described with reference to FIG. 23. FIG. 23 is a plan view of the particle capturing device 1D according to the fifth modification of one embodiment. The present modification corresponds to the electrode pair and the AC power supply more finely divided in the fourth modification. Hereinafter, the present embodiment will be described focusing on the differences from the embodiment described above.

As illustrated in FIG. 23, the particle capturing device 1D according to the present modification includes four electrode pairs 3C. Each electrode pair 3C includes an electrode 31C and an electrode 32C. The electrode 31C and the electrode 32C are connected to one end and the other end of the AC power supply 33C, respectively. The electrode pair 3C where the coupling well 41 is located corresponds to a first electrode pair in the present modification, and the electrode pair 3C where the second well 42 is located corresponds to a second electrode pair in the present modification. In addition, in the example of FIG. 23, each of the electrode 31C and the electrode 32C constitutes a line. The number of electrode pairs 3C included in the particle capturing device 1D may be three or less or five or more.

In the present modification, the particles captured in the second well 42 can be released separately from the particles captured in the coupling well 41. In the present modification, the captured particles can be collected for each pair of lines.

In the present modification, the AC power supply 33C is connected for each pair of lines. The present modification is not limited thereto, and an AC power supply may be connected for each line. As a result, the captured particles can be collected for each line. In this case, for example, the same number of AC power supplies as the number of lines are prepared, one end of each AC power supply is connected to each line, and the other end of each AC power supply is connected to a common ground. In this case, each combination of one line and the ground corresponds to one electrode pair. As another modification, the voltage applied to each line can be changed. As a result, it is possible to change the electrophoretic force and the capture ability generated even in the coupling well 41 or the single second well 42 having the same shape. For example, in the series of coupling wells 41 as well, by lowering the voltage on the upstream side and raising the voltage on the downstream side, it is possible to prevent a situation in which the particles captured on the upstream side become too dense and the particles overlap each other and obstruct the flow path of the particles flowing.

On the other hand, when the applied voltage for each line is constant, control is simplified and stable operation is expected. In the embodiment illustrated in FIG. 2, a coupling well 41 is provided on the upstream side of the flow path, and a large-diameter second well is provided on the downstream side, and the same voltage is applied to each well. As compared with the configuration in which the second well 42 to which a weak voltage is applied is provided on the upstream side and the second well 42 to which a strong voltage is applied is provided on the downstream side to give a difference in the capture ability between the upstream side and the downstream side, according to the configuration of the embodiment illustrated in FIG. 2, it is possible to generate a difference in the capture ability between the coupling well 41 on the upstream side and the second well 42 on the downstream side while applying the same voltage.

In the above description, the case of the living cell as the particle contained in the fluid has been described. The particle contained in the fluid is not limited thereto, and may be a living body such as a bacterium or a virus, a biopolymer such as DNA, RNA, or protein, various dielectrics including a resin, colloid, or the like, or a conductor such as a metal particle.

According to at least one embodiment described above, it is possible to selectively capture particles having a small size among the particles contained in the fluid.

While certain embodiments have been described, these embodiments have been presented by way of example only and are not intended to limit the scope of the inventions. The embodiments may be in a variety of other forms. Furthermore, various omissions, substitutions and changes may be made without departing from the spirit of the inventions. The embodiments and their modifications are included in the scope and the subject matter of the invention, and at the same time included in the scope of the claimed inventions and their equivalents.

1. A particle capturing device, comprising:
an electrode pair to which a voltage is applied; and
a capture membrane configured to be provided on the electrode pair and provided along at least one surface of a flow path to capture particles contained in a fluid flowing in the flow path by dielectrophoresis, wherein a coupling well for capturing the particles is formed in the capture membrane, and the coupling well has a plurality of first wells connected to each other.

2. The particle capturing device according to claim 1, wherein in the coupling well, the plurality of first wells are connected to each other by a connection well, and the connection well has a width smaller than a size of each of the first wells.

3. The particle capturing device according to claim 2, wherein each of the plurality of first wells is circular, and the connection well is rectangular.

4. The particle capturing device according to claim 2, wherein in the coupling well, a distance between centers of adjacent first wells is larger than a size of each of the first wells.

5. The particle capturing device according to claim 2, wherein in the coupling well, a distance between centers of adjacent first wells is equal to a size of a first target particle targeted to be captured by the coupling well.

6. The particle capturing device according to claim 1, wherein in the coupling well, the plurality of first wells are arranged in a direction oblique to a direction in which the fluid flows.

7. The particle capturing device according to claim 1, wherein a size of each of the plurality of first wells is equal to or less than a size of a first target particle targeted to be captured by the coupling well.

8. The particle capturing device according to claim 1, wherein a size of each of the plurality of first wells is less than twice a size of a first target particle targeted to be captured by the coupling well.

9. The particle capturing device according to claim 1, wherein sizes of the plurality of first wells are equal to each other.

10. The particle capturing device according to claim 1, wherein a first target particle targeted to be captured by the coupling well is a lymphocyte, a red blood cell, or a cluster comprising at least one of a lymphocyte and a red blood cell.

11. The particle capturing device according to claim 1, wherein a second well for capturing the particles is further formed in the capture membrane, and the second well is located on the downstream side of the coupling well in a direction in which the fluid flows, and
a size of the second well is larger than a size of each of the plurality of first wells.

12. The particle capturing device according to claim 11, wherein a second target particle targeted to be captured by the second well is a circulating tumor cell or a cluster comprising a circulating tumor cell.

13. The particle capturing device according to claim 11, wherein a particle captured in the second well is released separately from a particle captured in the coupling well.

14. The particle capturing device according to claim 13, comprising, as the electrode pair, a first electrode pair and a second electrode pair connected to different power supplies, wherein
the coupling well is located on the first electrode pair, and the second well is located on the second electrode pair.

15. The particle capturing device according to claim 11, wherein a third well for capturing the particles is further formed in the capture membrane, and the third well is located on the downstream side of the coupling well in the direction in which the fluid flows, and
a size of the third well is larger than a size of each of the plurality of first wells and is different from a size of the second well.

16. The particle capturing device according to claim 1, wherein the electrode pair comprises a first portion and a second portion adjacent to each other in a direction in which the fluid flows,
the voltage is applied between the first portion and the second portion, and
an upper surface of any one of the first portion and the second portion is exposed at a bottom portion of the coupling well.

17. The particle capturing device according to claim 1, wherein a plurality of the coupling wells are provided;
the plurality of the coupling wells comprises a first coupling well located on a downstream side in a first direction in which the fluid flows, and a second coupling well located on an upstream side in the first direction; and
the first coupling well is shifted from the second coupling well in a second direction orthogonal to the first direction.

18. The particle capturing device according to claim 1, wherein the capture membrane is an insulating film.

19. The particle capturing device according to claim 1, wherein a plurality of the coupling wells are provided, and
in the plurality of coupling wells, the plurality of first wells are configured to be inclined to the same side.

20. The particle capturing device according to claim 1, wherein the electrode pair is a pair of inter-digitated electrodes.
